(19) United States
(12) Patent Application Publication
(10) Pub. No.: US 2022/0290421 A1
(43) Pub. Date: Sep. 15, 2022

(54) PIPE CLEANER ASSEMBLY

(71) Applicant: AUTOMATION ASSOCIATES PTY LTD, Port Macquarie, NSW (AU)

(72) Inventor: Howard D. Bruce, Port Macquarie, NSW (AU)

(73) Assignee: AUTOMATION ASSOCIATES PTY LTD, Port Macquarie, NSW (AU)

(21) Appl. No.: 17/636,697

(22) PCT Filed: Aug. 19, 2020
(86) PCT No.: PCT/AU2020/050862

§ 371 Date: Feb. 18, 2022

(30) Foreign Application Priority Data
Aug. 20, 2019 (AU) 2019903022

(51) Int. Cl. E03F 9/00; B08B 9/045; E03C 1/302; B08B 9/055

(52) U.S. Cl. CPC E03F 9/005; B08B 9/045; E03C 1/302; B08B 9/0553; B08B 2209/055

(57) ABSTRACT

In one aspect there is disclosed a pipe cleaner assembly (10) operatively adapted to be located within a pipe obstructed with plant material. The pipe cleaner assembly (10) includes a cutting head (12) longitudinally extending about a cutting head axis (16) between a driving end (18) and a cutting end (20). The cutting head (12) defines a driving element slot (22) operatively adapted to hold an elongate driving element. The pipe cleaner assembly (10) further includes a cutting formation (14) operatively secured to the cutting head (12). The cutting formation (14) outwardly extends from the cutting end (18) of the cutting head (12) so that in use torque applied to the cutting head (12) by the driving element causes the cutting head (12) and as a result the cutting formation (14) to rotate about the cutting head axis (16) to cut plant material within the pipe.

### FIELD

The invention concerns a pipe cleaner assembly. In one particular, but non-exclusive, aspect the invention concerns a pipe cleaner assembly for use in removing plant materials such as tree roots from sewer lines.

### BACKGROUND

Tree root penetration in sewer lines can cause significant damage to pipes. Homeowners, businesses and municipalities have all experienced the effects of roots clogging a sewer line. Rapidly growing roots can leave infrastructure unusable thus necessitating substantial repair expenditure. Research have shown that more than half of all sewer blockages are the result of root invasion.

Tree roots naturally seek sources of moisture and are attracted to wastewater found in sewer lines. Roots can enter a sewer line through any joints or gaps between sewer pipes. As roots draw moisture from a sewer line, the roots will not only multiply but also expand. Over time such expansion will lead to structural decay of a pipe, eventually leading to the collapse of the pipe.

It has been found that older pipes are more prone to root growth. The more joints in a sewer line, the higher the possibility for root growth. Pipes made from materials such as clay, brick or concrete deteriorate over time, causing them to separate and crack due to ground shifting and erosion. Roots of trees proximate the sewer line can penetrate the line through such cracks. As those roots expand they can exert substantial force which can be of sufficient magnitude to break open the pipe.

Sewer lines are typically laid at depths of 2 meter or more below the ground surface. Tree roots which penetrate to such depths are referred to as “anchor roots”. Such roots can surround intact pipes without causing any damage. However, a crack in a pipe will allow roots to enter the pipe and grow rapidly. A cracked sewer line causes water and sewage to leak and air to escape into the surrounding soil. Such mixture of oxygen, water and nutrients will create a perfect environment for tree roots to thrive, causing anchor roots to grow fine feeder roots which penetrate the cracked pipe, overtime causing blockages and resulting damage.

Cleaning a root-clogged sewer line can be a difficult and costly undertaking. One method includes treating roots within a pipe with chemicals. Another method includes a mechanical routing device for cutting obstructing roots.

### OBJECT

It is an object of the present invention to provide an alternative pipe cleaner assembly for use in removing plant material, such as tree roots, from sewer lines.

### SUMMARY

According to a first aspect there is disclosed herein a pipe cleaner assembly operatively adapted to be located within a pipe obstructed with plant material, the pipe cleaner assembly including:

a cutting head longitudinally extending about a cutting head axis between a driving end and a cutting end, the cutting head defining a driving element slot operatively adapted to hold an elongate driving element; and

a cutting formation operatively secured to the cutting head, the cutting formation outwardly extending from the cutting end of the cutting head so that in use torque applied to the cutting head by the driving element causes the cutting head, and as a result the cutting formation, to rotate about the cutting head axis to cut plant material within the pipe.

Preferably the cutting head is moveable between (i) an open configuration in which a portion of the driving element is locatable within the driving element slot, and (ii) a closed configuration in which the portion of the driving element is secured within the driving element slot.

Preferably the cutting head includes a first cutting head section and a second cutting head section, the first cutting head section moveable relative to the second cutting head section to locate the cutting head in the open configuration.

Preferably the cutting head includes at least one fastener to secure the cutting head in the closed configuration.

Preferably the cutting head includes a plurality of fasteners to secure the cutting head in the closed configuration.

Preferably the cutting head includes two lateral cutting formation openings located on opposing sides of the cutting head axis.

Preferably the cutting head includes two cutting end holes which extend inwardly from the cutting end of the cutting head into the cutting formation openings.

Preferably the cutting formation includes two cutting arms operatively located on opposing sides of the cutting head.

Preferably each cutting arm includes (i) a cutting section outwardly extending from the cutting end of the cutting head, and (ii) an anchor section operatively located within one of the cutting formation openings.

Preferably the cutting formation includes a cutting arm connector connecting the two cutting arms.

Preferably each cutting arm extends through the cutting end hole of the respective cutting formation opening.

Preferably the cutting arm connector extends across the driving end of the cutting head to connect the two cutting arms.

Preferably the cutting arm connector includes a curved portion so that the cutting formation is deterred from obstructing the driving element slot.

Preferably the cutting arms are operatively adapted to be shaped between a restricted condition and an expanded condition.

Preferably the pipe cleaner assembly includes a cutting end clip, operatively mounted to the cutting end of the cutting head, adapted to secure the cutting arms in position.

Preferably the cutting end clip includes opposing cutting arm openings, each cutting arm opening operatively located opposite one of the cutting end holes to permit a cutting arm to pass therethrough.

Preferably the pipe cleaner assembly includes a driving end clip, operatively mounted to the driving end of the cutting head, adapted to secure the cutting arms in position.

Preferably the driving end clip includes opposing cutting arm openings, each cutting arm opening operatively located on opposite sides of the cutting head axis to permit a respective cutting arm to pass therethrough.

According to a second aspect there is disclosed herein a pipe cleaner assembly operatively adapted to be located within a pipe obstructed with plant material, the pipe cleaner assembly including:

a cutting head longitudinally extending about a cutting head axis between a driving end and a cutting end, the cutting head defining a driving element slot;

a cutting formation operatively secured to the cutting head, the cutting formation outwardly extending from the cutting end of the cutting head; and

an elongate driving element operatively associated with the cutting head,

wherein a portion of the driving element in secured within the driving element slot, in use torque applied to the cutting head by the driving element causing the cutting formation to rotate about the cutting head axis to cut plant material within the pipe.

Preferably the elongate driving element is flexible.

Preferably driving element is enclosed within a protective cover.

Preferably the driving element is a cable.

Preferably the cable is produced from spring steel.

According to a further aspect there is disclosed herein a method of clearing plant material blocking a pipe, the method include the steps of (i) providing a pipe cleaner assembly according to the above aspects; (ii) cutting plant material with the pipe cleaner assembly; (iii) providing a supply of water; and (iv) feeding cut plant material along the pipe under the influence of the supply of water.

### BRIEF DESCRIPTION OF THE DRAWINGS

Preferred embodiments of the invention will be described hereinafter, by way of examples only, with reference to the accompany drawings, wherein:

FIG. 1 is a schematic perspective front view of a cutting head and cutting formation of an embodiment pipe cleaner assembly;

FIG. 2 is a schematic perspective rear view of the cutting head and cutting formation of FIG. 1;

FIG. 3 is a schematic perspective front view of a second embodiment pipe cleaner assembly;

FIG. 4 is a schematic perspective rear view of the pipe cleaner assembly of FIG. 3;

FIG. 5 is a schematic perspective view of a third embodiment pipe cleaner assembly;

FIG. 6 is a schematic perspective view of the pipe cleaner assembly of FIG. 6 to be inserted into a sewer pipe; and

FIG. 7 is a schematic perspective view of a fourth embodiment pipe cleaner assembly.

### DESCRIPTION OF PREFERRED EMBODIMENTS

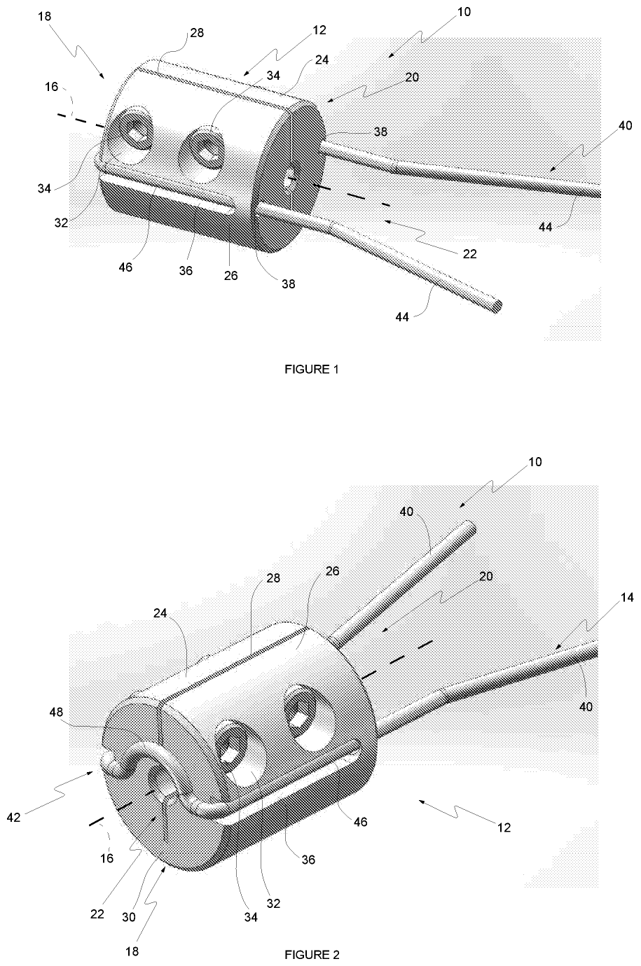

FIGS. 1 and 2 show an embodiment pipe cleaner assembly, generally indicated with the reference numeral 10. The pipe cleaner assembly 10 is operatively adapted to be located within a non-illustrated sewer pipe obstructed with plant material such as tree roots. As is discussed below, the pipe cleaner assembly 10 is operatively adapted to cut the obstructing plant material. The cut/mulched plant material can then be pushed into a forward direction to clearing in the pipe to be fed away will a small amount of water as discussed below. The pipe cleaner assembly 10 includes a cutting head 12 and a cutting formation 14.

The cutting head 12 longitudinally extends about a cutting head axis 16 between a driving end 18, operatively facing away from the pipe blocked with tree roots, and a cutting end 20, operatively facing towards obstructing tree roots. The embodiment cutting head 12 is of cylindrical shape. The cutting head 12 defines a driving element slot 22. The driving element slot 22 is operatively adapted to hold a non-illustrated driving element. The cutting head 12 is moveable between (i) a non-illustrated open configuration in which a portion of the non-illustrated driving element can be located within the driving element slot 22, and (ii) a closed configuration, depicted in FIGS. 1 and 2, in which the portion of the non-illustrated driving element is secured within the driving element slot 22.

The cutting formation 14 is operatively secured to the cutting head 12. The cutting formation 14 outwardly extends from the cutting end 20 of the cutting head 12. In use torque applied to the cutting head 12 by the non-illustrated driving element will cause the cutting head 12, and as a result the cutting formation 14, to rotate about the cutting head axis to cut obstructing tree roots within the pipe. Cut tree root parts can then be fed away along the pipe with water thereby removing the obstruction from the pipe.

The cutting head 12 includes a first cutting head section 24 and a second cutting head section 26. The first cutting head section 24 is separated from the second cutting head section 26 via a slot section 28 and connected at one section via a common section 30. This arrangement permits the second cutting head section 26 to be moved relative to the first cutting head section 24, thereby locating the cutting head 12 in the open configuration. When the cutting head 12 is located within the closed configuration a portion of the driving element is effectively clamped in position within the driving element slot 22. To secure the cutting head 12 in its closed configuration the cutting head 12 defines two threaded holes 32 which are engaged by two threaded fasteners 34.

The cutting head 12 includes two laterally spaced apart cutting formation openings 36 located on opposing sides of the cutting head axis 16. The cutting head 12 further includes two cutting end holes 38 which extend inwardly from the cutting end 20 of the cutting head 12 into the cutting formation openings 36.

The cutting formation 14 includes (i) two cutting arms 40 operatively located on opposing sides of the cutting head 12, and (ii) a cutting arm connector 42 connecting the two cutting arms 40. Each cutting arm 40 includes (i) a cutting section 44 outwardly extending from the cutting end 20 of the cutting head 12, and (ii) an anchor section 46 operatively located within a corresponding cutting formation opening 22. Each cutting arm 40 extends through the cutting end hole 38 of its respective cutting formation opening 22.

As shown in FIG. 2, the cutting arm connector 42 extends across the driving end 18 of the cutting head 12 to connect the two cutting arms 40. The cutting arm connector 42 includes a curved portion 48 so that the cutting formation 14 is deterred from obstructing the driving element slot 22 and as a result the non-illustrated driving element.

The cutting arms 40 are produced from a material which permits them to be shaped/manipulated between a non-illustrated restricted condition (in which the cutting arms 40 overlap) and an expanded condition depicted in FIGS. 1 and 2. The restricted condition will typically be employed at the beginning of a cutting process. Typically, a water conduit will be located within the pipe to supply water for removing cut debris. Once the cutting head 12 has cut an initial hole through the obstructing plant material in a pipe, the pipe cleaner assembly 10 is removed from the pipe, the cutting arms 40 located in their expanded position and the pipe cleaner assembly 10 returned to the initial cut hole to enlarge the diameter of the initial hole. The cutting process is performed until the obstructing plant material has been cut and cut debris flushed out and swept away along the pipe.

In the above embodiment the cutting formation 14 is produced from stainless steel wire.

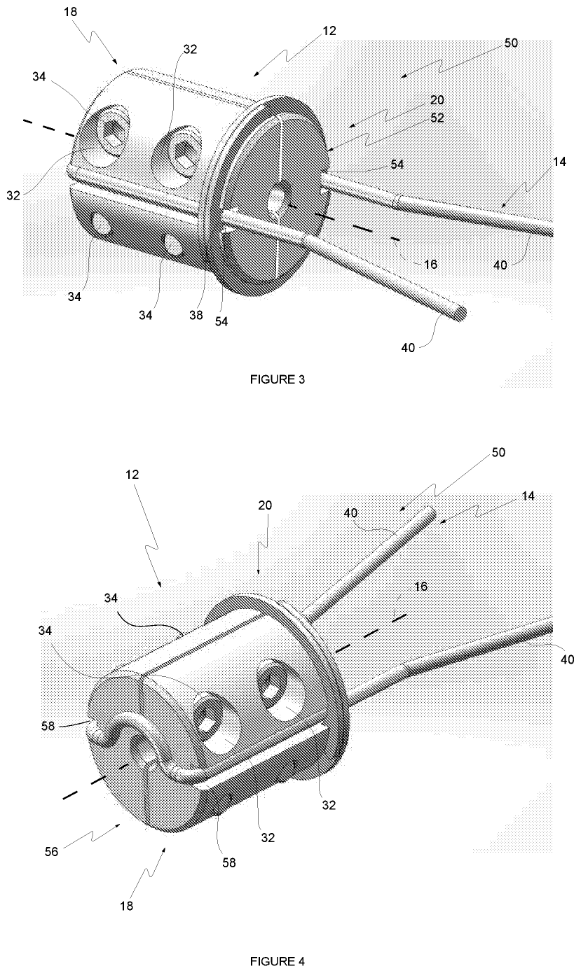

FIGS. 3 and 4 show a second embodiment pipe cleaner assembly 50. The pipe cleaner assembly 50 is similar to the pipe cleaner assembly 10 in that it includes a cutting head 12 and a cutting formation 14. Unlike the pipe cleaner assembly 10, the pipe cleaner assembly 50 includes four threaded fastener holes 32 which hold 4 corresponding threaded fasteners 34.

The pipe cleaner assembly 50 further includes a cutting end clip 52, operatively mounted to the cutting end 20 of the cutting head 12. The cutting end clip 52 is adapted to secure the cutting arms 40 of the cutting formation 12 in position. The cutting end clip 52 includes opposing cutting arm openings 54. Each cutting arm opening 54 is operatively located opposite one of the cutting end holes 38 to permit a respective cutting arm 40 to pass therethrough.

The pipe cleaner assembly 50 also includes a driving end clip 56 which is operatively mounted to the driving end 18 of the cutting head 12 and adapted to secure the cutting arms 40 in position. The driving end clip 56 includes opposing cutting arm openings 58. Each cutting arm opening 58 is operatively located on opposite sides of the cutting head axis 16 to permit the cutting arms 40 to pass therethrough.

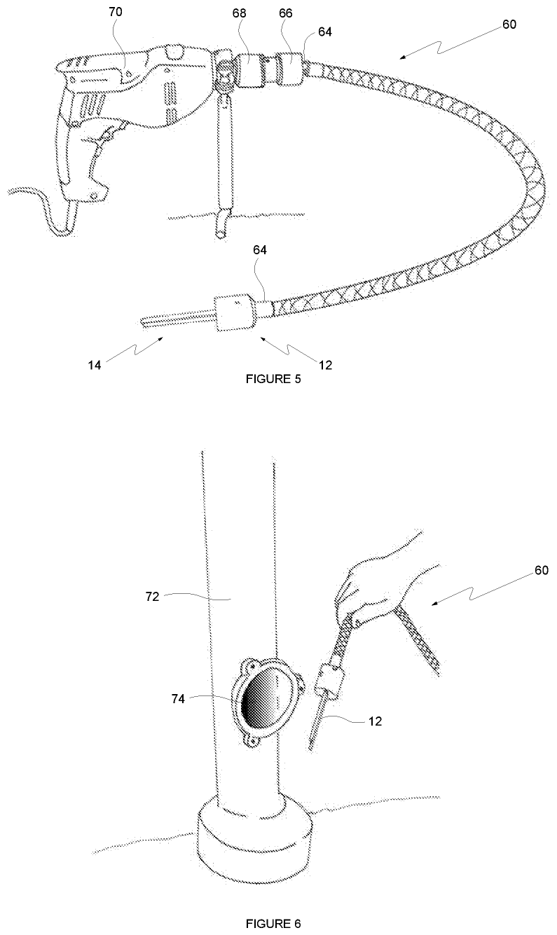

FIG. 5 shows a third embodiment pipe cleaner assembly 60. The third embodiment pipe cleaner assembly 60 includes a cutting head and cutting formation 12, 14 as shown above. The pipe cleaner assembly 60 includes an elongate protective cover 62. The protective cover 62 houses an elongate flexible driving element 64, here a high tensile spring steel cable. The cutting formation 12 is attached to the driving element 64. At its opposite end the driving element 64 is attached to a coupling 66. The coupling 66 is inserted into the chuck 68 of an electric hand drill 70. In one application the electric drill is a 750W drill which runs at approximately 3,000 rpm. This has been found to be effective for driving the driving element 64 and as a result the cutting head 12 and cutting assembly 14. FIG. 6 illustrates the cutting head 12 being of the pipe cleaner assembly 60 located proximate a sewer pipe 72 prior to being inserted into the sewer pipe 72 via a hole 74.

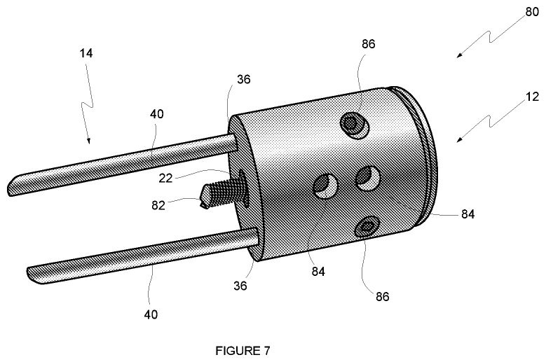

FIG. 7 shows a fourth embodiment pipe cleaner assembly, generally indicated with the reference numeral 80. The pipe cleaner assembly 80 includes a cutting head 12 and a cutting formation 14. The cutting head 12 defines a driving element slot 22 operatively adapted to hold a driving element 82, here in the form of a length of cable. The driving element 80 is secured to the cutting head 12 with the use of non-illustrated threaded cutting element fasteners which threadingly engage cutting element fastener holes 84.

The cutting formation 14 includes two laterally spaced-apart co-extensive cutting arms 40, here in the form of steel wire, located within cutting formation openings 36. The cutting arms 40 are secured within the cutting formation openings 36 with the use of threaded cutting arm fasteners 86. The operation of the fourth embodiment pipe cleaner assembly 80 is as discussed for the above embodiments.

Although the invention has been described with reference to specific examples, it will be appreciated by those skilled in the art that the invention may be embodied in many other forms.

### KEY TO REFERENCE NUMERALS

10 First embodiment pipe cleaner assembly
12 Cutting head
14 Cutting formation
16 Cutting head axis
18 Driving end
20 Cutting end
22 Driving element slot
24 First cutting head section
26 Second cutting head section
28 Slot section
30 Common section
32 Threaded holes
34 Threaded fastener
36 Cutting formation opening
18 Two cutting end holes
40 Cutting arms
42 Cutting arm connector
44 Cutting section
46 Anchor section
48 Curved portion
50 Second embodiment pipe cleaner assembly
52 Cutting end clip
54 Cutting arm openings
56 Driving end clip
58 Cutting arm openings
60 Third embodiment pipe cleaner assembly
62 Protective cover
64 Driving element
66 Coupling
68 Chuck
70 Electric hand drill
72 Sewer pipe
74 Hole
80 Fourth embodiment pipe cleaner assembly
82 Driving element
84 Cutting element fastener hole
86 Cutting arm fastener

1. A pipe cleaner assembly operatively adapted to be located within a pipe obstructed with plant material, the pipe cleaner assembly including:
a cutting head longitudinally extending about a cutting head axis between a driving end and a cutting end, the cutting head defining a driving element slot operatively adapted to hold an elongate driving element; and
a cutting formation operatively secured to the cutting head, the cutting formation outwardly extending from the cutting end of the cutting head so that in use torque applied to the cutting head by the driving element causes the cutting head, and as a result the cutting formation, to rotate about the cutting head axis to cut plant material within the pipe.

2. A pipe cleaner assembly according to claim 1, wherein the cutting head is moveable between (i) an open configuration in which a portion of the driving element is locatable within the driving element slot, and (ii) a closed configuration in which the portion of the driving element is secured within the driving element slot.

3. A pipe cleaner assembly according to claim 2, wherein the cutting head includes a first cutting head section and a second cutting head section, the first cutting head section being moveable relative to the second cutting head section to locate the cutting head in the open configuration.

4. A pipe cleaner assembly according to claim 3, wherein the cutting head includes at least one fastener to secure the cutting head in the closed configuration.

5. A pipe cleaner assembly according to claim 4, wherein the cutting head includes a plurality of fasteners to secure the cutting head in the closed configuration.

6. A pipe cleaner assembly according to claim 1, wherein the cutting head includes two laterally spaced apart cutting formation openings located on opposing sides of the cutting head axis.

7. A pipe cleaner assembly according to claim 6, wherein the cutting head includes two cutting end holes which extend inwardly from the cutting end of the cutting head into the cutting formation openings.

8. A pipe cleaner assembly according to claim 1, wherein the cutting formation includes two cutting arms operatively located on opposing sides of the cutting head.

9. A pipe cleaner assembly according to claim 8, wherein each cutting arm includes a cutting section outwardly extending from the cutting end of the cutting head.

10. A pipe cleaner assembly according to claim 9, wherein each cutting arm extends through the cutting end hole of the respective cutting formation opening.

11. A pipe cleaner assembly according to claim 10, wherein the cutting arms are operatively adapted to be shaped between a restricted condition and an expanded condition.

12. A pipe cleaner assembly according to claim 11, including a cutting end clip, operatively mounted to the cutting end of the cutting head, adapted to secure the cutting arms in position.

13. A pipe cleaner assembly operatively adapted to be located within a pipe obstructed with plant material, the pipe cleaner assembly including:
a cutting head longitudinally extending about a cutting head axis between a driving end and a cutting end, the cutting head defining a driving element slot;
a cutting formation operatively secured to the cutting head, the cutting formation outwardly extending from the cutting end of the cutting head; and
an elongate driving element operatively associated with the cutting head,
wherein a portion of the driving element is secured within the driving element slot, in use torque applied to the cutting head by the driving element causes the cutting formation to rotate about the cutting head axis to cut plant material within the pipe.

14. A pipe cleaner assembly according to claim 13, wherein the elongate driving element is flexible.

15. A pipe cleaner assembly according to claim 14, wherein the driving element is enclosed within a protective cover.

16. A pipe cleaner assembly according to claim 14, wherein the driving element is cable.

17. A pipe cleaner assembly according to claim 16, wherein the cable is produced from spring steel.

18. (canceled)

19. A method of clearing plant material blocking a pipe, the method including the steps of (i) providing a pipe cleaner assembly according to claim 1; (ii) cutting plant material with the pipe cleaner assembly; (iii) providing a supply of water; and (iv) feeding cut plant material along the pipe under the influence of the supply of water.
